(19) United States
(12) Patent Application Publication
(10) Pub. No.: US 2006/0185786 A1
(43) Pub. Date: Aug. 24, 2006

(54) Flexible PVC hose and method of making

(76) Inventors: Emilio Priore Neto, Sao Paulo (BR); Luis Roberto Flores Sanches, Sao Paulo (BR); Antonio Rodrigues da Silva, Sao Paulo (BR)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 11/061,214

(22) Filed: Feb. 18, 2005

(51) Int. Cl. B29C 63/10

(52) U.S. Cl. 156/187; 156/244.11

(57) ABSTRACT

The present invention is directed to a method of making a flexible hose, comprising the steps of extruding a first poly(vinyl chloride) compound to form a tube, the tube having an inner cylindrical cavity coextensive with the tube; a) applying a textile reinforcement over the tube; b) extruding a second poly(vinyl chloride) compound over the textile reinforcement to form a cover layer, said tube, reinforcement and cover defining a hose composite; c) inserting a rigid mandrel into the inner cylindrical cavity; d) wrapping a fabric wrap around the outside of the cover of the hose composite; and e) processing the wrapped hose composite at a temperature in a range of 130 to 160° C. and a pressure of 30 to 70 psig for a time ranging from 5 to 40 minutes.

This application claims priority from Provisional Application No. 60/545,265, filed Feb. 17, 2004.

### BACKGROUND OF THE INVENTION

Flexible poly(vinyl chloride) (i.e., PVC) hoses are made for general use with liquids and gases, such as water and air. Typically, a flexible PVC hose has a three-layer construction with a PVC inner tube, a textile reinforcement, and a PVC cover. In order to improve the adhesion of the PVC layers to the reinforcement, adhesive compositions are sometimes applied to the reinforcement. However, there remains a need to improve the adhesion and burst strength of flexible PVC hoses.

### SUMMARY OF THE INVENTION

The present invention is directed to a method of making a flexible hose, comprising the steps of extruding a first poly(vinyl chloride) compound to form a tube, the tube having an inner cylindrical cavity coextensive with the tube; a) applying a textile reinforcement over the tube; b) extruding a second poly(vinyl chloride) compound over the textile reinforcement to form a cover layer, said tube, reinforcement and cover defining a hose composite; c) inserting a rigid mandrel into the inner cylindrical cavity; d) wrapping a fabric wrap around the outside of the cover of the hose composite; and e) processing the wrapped hose composite at a temperature in a range of 130 to 160° C. and a pressure of 30 to 70 psig for a time ranging from 5 to 40 minutes.

### BRIEF DESCRIPTION OF THE DRAWINGS

FIG. 1 is a side view of a hose of the present invention; and

FIG. 2 is a schematic representation of the method of the present invention.

### DESCRIPTION OF THE PREFERRED EMBODIMENT

There is disclosed a method of making a flexible hose, comprising the steps of extruding a first poly(vinyl chloride) compound to form a tube, the tube having an inner cylindrical cavity coextensive with the tube; a) applying a textile reinforcement over the tube; b) extruding a second poly(vinyl chloride) compound over the textile reinforcement to form a cover layer; said tube, reinforcement and cover defining a hose composite; c) inserting a rigid mandrel into the inner cylindrical cavity; d) wrapping a fabric wrap around the outside of the cover of the hose composite; and e) processing the wrapped hose composite at a temperature in a range of 130 to 160° C. and a pressure of 30 to 70 psig for a time ranging from 5 to 40 minutes.

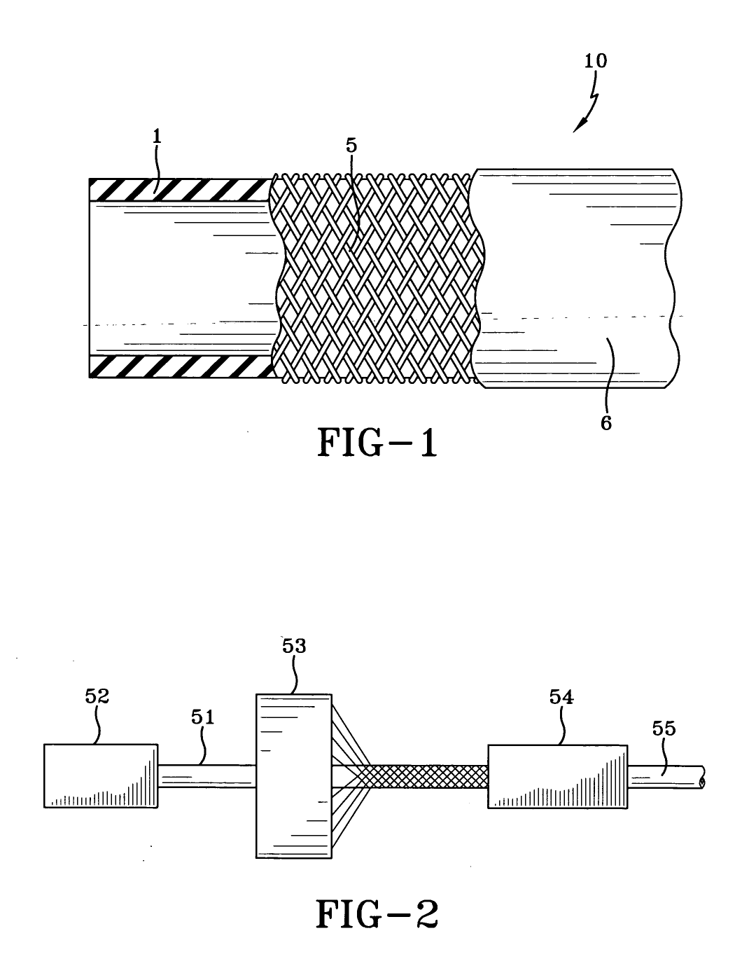

Reference is now made to the Figures. FIG. 1 shows a hose 10 made according to the methods of the present invention. Hose 10 includes an inner tube 1 formed from a flexible poly(vinyl chloride) compound. Reinforcement layer 5 overlays tube 1 and is formed from a conventional textile yarn. Cover layer 6 overlays reinforcement layer 5 and is formed from a flexible poly(vinyl chloride) compound.

FIG. 2 is a simplified schematic representation of the method of manufacturing flexible hose 10. A solid mandrel may be employed in the manufacture of this hose. An unsupported elastomeric tube member 1 is produced using conventional tube making equipment such as an extruder 52. Tube member 1 may optionally have positive pressure applied inside to assist in maintaining its circular cross-section. FIG. 2 shows the elastomeric tube 1 being fed directly to a braider 53 for application of the textile reinforcement 5. It should be noted that the process for manufacturing the elastomeric tube may be such that it is desirable for the elastomeric tube to be produced in a separate step and later fed into the braider 53. Conventional braider equipment may be utilized.

Once the desired textile reinforcement has been applied, an elastomeric cover 6 is applied over the braided sleeves by cover applicator 54. Any conventional process for application of cover layers to a hose may be utilized with the most common method being the use of a cross-head extruder. The composite hose 10 exits from the cover applicator 54 and proceeds to the heating process 56. The heating process may be any conventionally known method of curing or vulcanizing hose wherein heat and pressure are applied. One curing method in which an additional step is required is a fabric-wrap method in which fabric is spiraled over the uncured hose composite for the purpose of applying external pressure to the composite prior to the introduction of the uncured hose composite to the high temperature curing conditions. In a preferred embodiment, the hose 10 is forced over a rigid mandrel and processed in a steam autoclave at elevated temperature and pressure. Typically, a long length of hose 10, for example 100 feet, is forced over a rigid steel mandrel and batch processed in a steam autoclave. A suitable autoclave is described in U.S. Pat. No. 4,228,134.

The temperature of the heating process may range from 130° C. to 160° C. Alternatively, the temperature may range from 135 to 155° C. The pressure of the heating process may range from 30 psig to 70 psig. Alternatively, the pressure may range from 40 to 60 psig. The processing time for the application of heat and pressure to the hose may range from 5 to 40 minutes. Alternatively, the time may range from 10 to 30 minutes.

Common ingredients which are added to the PVC compound for use in the hose tube and cover include lubricants (0.35 phr to 0.45 phr), stabilizers (3 to 4 phr), plasticizers (50 to 70 phr), and pigments (0.0001 to 0.001 phr). The above levels of conventional ingredients may be varied, depending on the hose, so long as the specific gravity criteria is observed. For example, the amount of pigment may be increased depending on the desired color if a clear hose is not desired. To obtain a lower weight hose, the PVC compound may include blowing agents to obtain a foamed PVC.

The textile reinforcement may be any suitable reinforcing yarn, such as polyester, nylon, aramid, rayon, glass, and the like. In one embodiment, the reinforcing yarn is polyester. The reinforcement may be applied by one of the methods as are known in the art, including spiraling, braiding, and the like. In one embodiment, the textile yarn is braided onto the tube.

The invention is further illustrated by the following non-limiting example.

### EXAMPLE

Four PVC hoses samples were prepared that had the design of FIG. 1. Each hose had a PVC tube, polyester reinforcement layer, and PVC cover layer. Samples 1 and 3 were control samples, and Samples 2 and 4 represented the present invention. The hoses were produced following the procedure as illustrated in FIG. 2. For Samples 2 and 4, each hose was mounted on a steel mandrel and wrapped in a helical fabric wrap, followed by processing in an autoclave at 146° C. and 54 psig for 20 minutes. Control hose (Samples 1 and 3) and hose processed according to the invention (Samples 2 and 4) was tested for adhesion between the PVC cover and textile reinforcement, adhesion between the textile reinforcement and the PVC tube, and for burst strength. Burst strength adhesive strength were measured following ASTM D-380. Results are given in Table 1.

TABLE 1

| | 1 | | 3 | |
|---|---|---|---|---|
| Sample No. | control | 2 | control | 4 |
| Tube ID, inch | 0.75 | 0.75 | 1 | 1 |
| Adhesive Strength | | | | |
| Cover/Yarn, lb./in. | 12.5 | 17.2 | 13.3 | 26.8 |
| Yarn/Tube, lb./in. | 18.2 | 26.8 | 13.9 | 22.1 |
| Burst, psi | 800 | 1000 | 1200 | 1300 |

As is evident from the data of Table 1, flexible PVC hoses made according to the methods of the present invention show significantly improved adhesive strength and burst strength as compared with flexible PVC hoses made without the application of heat and pressure. For example, the burst strengths in Table 1 show an improvement ranging from about 8 to about 25 percent greater for hoses processed with heat and pressure (Samples 2 and 4), as compare with the control hoses that were not processed with heat and pressure (Samples 1 and 3). More generally, hoses made according to the present invention may have burst strengths of from 5 to 50 percent greater than hoses made without heat and pressure. The adhesive strengths in Table 1 show an improvement ranging from about 38 to about 200 percent greater for hoses processed with heat and pressure (Samples 2 and 4), as compare with the control hoses that were not processed with heat and pressure (Samples 1 and 3). More generally, hoses made according to the present invention may have adhesive strengths of from 25 to 250 percent greater than hoses made without heat and pressure.

While not wishing to be bound by any particular theory, it is believed that the application of heat and pressure to obtain the flexible hose of the present invention results in a better impregnation of the textile reinforcement layer with the thermoplastic PVC from the tube and cover layers. It is believed that during the application of heat and pressure, the PVC softens and flows between the textile yarns, to obtain a mechanical interlocking as well as a commingling of the polymer from the tube and cover.

While present exemplary embodiments of this invention and methods of practicing the same have been illustrated and described, it will be recognized that this invention may be otherwise variously embodied and practiced within the scope of the following claims.

What is claimed is:

1. A method of making a flexible hose, comprising the steps of
extruding a first poly(vinyl chloride) compound to form a tube, the tube having an inner cylindrical cavity coextensive with the tube;
a) applying a textile reinforcement over the tube;
b) extruding a second poly(vinyl chloride) compound over the textile
reinforcement to form a cover layer, said tube, reinforcement and cover defining a hose composite;
c) inserting a rigid mandrel into the inner cylindrical cavity;
d) wrapping a fabric wrap around the outside of the cover of the hose composite; and
e) processing the wrapped hose composite at a temperature in a range of 130 to 160° C. and a pressure of 30 to 70 psig for a time ranging from 5 to 40 minutes.

2. The method of claim 1, wherein the first and second poly(vinyl chloride) compounds are of the same recipe.

3. The method of claim 1, wherein the textile reinforcement is selected from the group consisting of polyester, nylon, aramid, rayon, and glass.

4. The method of claim 1, wherein the textile reinforcement is polyester.

5. The method of claim 1, wherein the hose is processed as a temperature of from 135° C. to 155° C.

6. The method of claim 1, wherein the hose is processed at a pressure of from 40 to 60 psig.

7. The method of claim 1, wherein the hose is processed for a time of from 10 minutes to 30 minutes.

8. The method of claim 1, wherein the processing occurs in a steam autoclave.

9. The method of claim 1, wherein the hose has a burst strength as measured by ASTM D-380 ranging from 5 to 50 percent greater than a hose made only with steps a) and b) and not steps c), d) and e).

10. The method of claim 1, wherein the hose has a burst strength as measured by ASTM D-380 ranging from 8 to 25 percent greater than a hose made only with steps a) and b) and not steps c), d) and e).

11. The method of claim 1, wherein the hose has an adhesive strength as measured by ASTM D-380 ranging from 38 to 200 percent greater than a hose made only with steps a) and b) and not steps c), d) and e).

12. The method of claim 1, wherein the hose has an adhesive strength as measured by ASTM D-380 ranging from 25 to 250 percent greater than a hose made only with steps a) and b) and not steps c), d) and e).

13. A hose made by the method of claim 1.
